(19) United States
(12) Patent Application Publication
(10) Pub. No.: US 2024/0069695 A1
(43) Pub. Date: Feb. 29, 2024

(54) Method for Grouping and Managing Web Pages or Browser and Non-Browser Tabs in Two-Dimensional Manner

(71) Applicant: Pete Phillip Bragansa, New York, NY (US)

(72) Inventor: Pete Phillip Bragansa, New York, NY (US)

(21) Appl. No.: 18/124,779

(22) Filed: Mar. 22, 2023

Related U.S. Application Data
(60) Provisional application No. 63/401,724, filed on Aug. 29, 2022.

(51) Int. Cl. G06F 3/0483; G06F 3/04845; G06F 16/955; G06F 16/957

(52) U.S. Cl. CPC G06F 3/0483; G06F 3/04845; G06F 16/9562; G06F 16/9577; G06F 3/04842

(57) ABSTRACT

A method for grouping and managing web pages or browser tabs is described. The method is processed on a device to assign visual objects such as boxes to website or browser or non-browser objects such as text or images or application shortcuts and, group and manage them as two-dimensional moveable boxes. The method also includes bookmarking a number of selected boxes from the extension or software and saving box arrangements. The method also includes selecting boxes with a point and drag and performing a variety of functions with a multi-select point and drag.

The method comprises previewing web pages in the box as a thumbnail using a preview function. The method also includes automatically grouping and arranging boxes or tabs by words in the tab name or URL, alphabetically, or most recently opened up, and creating assignable numbers for each box and a command to navigate to that tab via an assignable number for boxes.

### I. RELATED APPLICATIONS

This application claims the benefit of priority to Provisional Application No. 63/401,724 filed on Aug. 29, 2022, and entitled “METHOD FOR GROUPING AND MANAGING WEB PAGES OR BROWSER AND NON-BROWSER TABS IN TWO-DIMENSIONAL MANNER”, which is incorporated herein by reference in its entirety.

### II. FIELD OF THE INVENTION

The present invention relates to methods for displaying and manipulating information for example, in a web browser, and, more particularly, relates to a method for assigning boxes of various shapes to web pages, non-website tabs, or websites (currently assigned as tabs), data, or any other software application configured to display data & records, and grouping and managing these boxes on, for example, internet web browser tabs, software applications, or websites and non-browser tabs. Numerous attempts have been made to improve methods and techniques for displaying and manipulating information for example, on a digital interface.

### III. BACKGROUND

The “Internet,” a global network of computers, has grown rapidly in recent years. This expansion has been fueled primarily by the introduction and widespread use of so-called “web” browsers, which enable simple graphical user interface (GUI)-based access to network servers that support documents formatted as so-called “web pages.” The “World Wide Web” (WWW) is a collection of Internet servers that use the Hypertext Transfer Protocol (HTTP) (HTTP).

A large number of portable computing devices, such as cellular phones, tablets, and E-Readers, use a touchscreen display not only to display information to the user but also to receive input from user interface commands. While touchscreen displays can increase the configurability of a handheld device and offer a wide range of user interface options, this flexibility usually comes at a cost.

With the popularity of the Internet, using a browser to connect to the Internet for the purpose of browsing web pages or gathering information has become a part of everyday life. By observing general users' browsing habits on web pages, it is discovered that while the users browse web pages, they are frequently drawn to the information contained therein and wish to view further details of the information. Users are used to keeping the current page and choosing to open a new window or a new tab to view the desired information because they do not want to leave the current page.

Conventional methods of organizing data, for example on a web browser or non-browser tabs consist of organizing said data in a one-dimensional plane. Examples of common data organized in such a one-dimensional plane include tabs, sections related to websites, contact info, messaging, communication, task project management, customer relationship management, database software or other info/data where data is commonly separated or organized into sections, tabs, lines of text, etc. which are arranged linearly in a single dimension. It is clear that conventional one-dimensional organization is limiting and inefficient.

Accordingly, there exists a need for a device or method to improve methods and techniques used for computer interfaces. More specifically, there exists a need for a device or method to display and manipulate information broadcast on a digital interface. Further, there exists a need for a method for arranging and organizing internet browser tabs or websites and non-browser tabs in two dimensions by moving the apart or together in groups.

This background information is provided for the purpose of making information believed by the applicant to be of possible relevance to the present invention. Notwithstanding, no admission is necessarily intended, nor should it be construed, that any of the preceding information constitutes prior art against the present invention. In addition, the preceding information should not be construed to mean that a search has been made or that no other pertinent information as defined in 37 CFR § 1.56(a) exists.

### IV. SUMMARY

The present disclosure provides a method and apparatus for arranging and organizing internet browser tables or websites and non-browser tabs in two dimensions by moving them apart or together in groups either automatically based on a predefined order or as per the user's requirement. All references mentioned in this disclosure are hereby incorporated by reference in their entirety.

It is well known by those skilled in the art that there is a long-felt need in the industry to arrange and organize items that appear on a digital interface, for example, one connected to the internet. The inventor surprisingly discovered an improved method of achieving the same.

One aspect of the invention pertains to a method for grouping and managing internet web browser tabs, non-browser tabs or websites, the method comprising: grouping and managing a plurality of web pages or browser tabs in a browser using a device or software; assigning a box to each web page of the plurality of web pages or data; and moving, organizing and managing the boxes in two dimensions; bookmarking a plurality of selected boxes from an extension of the browser or software and saving arrangements of boxes using a Bookmark and Arrangement-saving functionality adapted by a user to bookmark; selecting boxes with a point and drag process and perform a plurality of functions using a multi-select point and drag process; customizing a name of two or more boxes; associating boxes or associating tabs together to be grouped by performing association or grouping of boxes; typing and coloring areas in a canvas; previewing a page or record in a box as a thumbnail using a preview function; and grouping and arranging boxes or tabs by words.

A further aspect of the invention pertains to non-transitory computer-readable medium which, when executed by a processor, causes a device to perform a method comprising: grouping and managing a plurality of web pages, non-browser tabs, or browser tabs in a browser or software using a device; assigning a box to each web page of the plurality of web pages or records; and moving, organizing and managing the boxes in two dimensions; bookmarking a plurality of selected boxes from an extension of the browser or software and saving arrangements of boxes using a Bookmark and Arrangement-saving functionality adapted by a user to bookmark; selecting boxes with a point and drag process and perform a plurality of functions using a multi select point and drag process; customizing a name of two or more boxes; associating boxes or associating tabs together to be grouped by performing association or grouping of boxes; typing and coloring areas in a canvas; previewing a page in a box as a thumbnail using a preview function; and grouping and arranging boxes or tabs by words.

### V. BRIEF DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 illustrates a perspective view of boxes showing management of internet web browser tabs or websites, in accordance with an embodiment of the present invention disclosed herein.

FIG. 2 illustrates a process flowchart for a method for grouping and managing internet web browser tabs or websites, in accordance with an embodiment of the present invention disclosed herein.

FIG. 3 illustrates a perspective view of boxes showing management of internet web browser tables or non-browser tabs or websites from other software applications, in accordance with an embodiment of the present invention as disclosed herein.

The headings used herein are for organizational purposes only and are not meant to be used to limit the scope of the description. As used throughout this application, the word “may” is used in a permissive sense (i.e., meaning having the potential to), rather than the mandatory sense (i.e., meaning must). Similarly, the words “include,” “including,” and “includes” mean including but not limited to. To facilitate understanding, like reference numerals have been used, where possible, to designate like elements common to the figures. Optional portions of the figures may be illustrated using dashed or dotted lines unless the context of usage indicates otherwise.

### VI. DETAILED DESCRIPTION

### Definitions

For the purposes of promoting an understanding of the principles of the invention, reference will now be made to certain embodiments and specific language will be used to describe the same. It will nevertheless be understood that no limitation of the scope of the invention is thereby intended, and alterations and modifications in the illustrated invention and further applications of the principles of the invention as illustrated therein are herein contemplated as would normally occur to one skilled in the art to which the invention relates.

Unless defined otherwise, all technical and scientific terms used herein have the same meaning as commonly understood by one of ordinary skill in the art to which this invention pertains.

For the purpose of interpreting this specification, the following definitions will apply and whenever appropriate, terms used in the singular will also include the plural and vice versa. In the event that any definition set forth below conflicts with the usage of that word in any other document, including any document incorporated herein by reference, the definition set forth below shall always control for purposes of interpreting this specification and its associated claims unless a contrary meaning is clearly intended (for example in the document where the term is originally used).

The use of “or” means “and/or” unless stated otherwise.

The use of “a” or “an” herein means “one or more” unless stated otherwise or where the use of “one or more” is clearly inappropriate.

The use of “comprise,” “comprises,” “comprising,” “include,” “includes,” and “including” are interchangeable and not intended to be limiting. Furthermore, where the description of one or more embodiments uses the term “comprising,” those skilled in the art would understand that, in some specific instances, the embodiment or embodiments can be alternatively described using the language “consisting essentially of” and/or “consisting of.”

As used herein, the term “about” refers to a ±10% variation from the nominal value. It is to be understood that such a variation is always included in any given value provided herein, whether or not it is specifically referred to.

As used herein, the term “app” generally refers to an electronic interactive application used on a computer or mobile device.

As used herein, the term “Computer interface” generally refers to any electronic device having the capability to interact with a user.

As used herein, the term “tabs” generally refers to any tab section, line or lines of text, area, or other boundary containing information or data, that denotes or represents data, data record(s), or information that is separate from other information, data, or data record(s) but is not a website or would not be displayed as a tab in a web browser or containing information or data that is or is not in communication with the internet.

As used herein, the term “software” generally refers to programs used to direct the operation of a computer.

As used herein, the term “database” generally refers to a collection of organized data for computer access.

As used herein the term “Web Browser” generally refers to a media through which the world wide web is accessed.

As used herein, the term “two-dimensional” generally refers to the arrangement of items in at least one locational plane defined by one or more of an x-axis and a perpendicular.

As used herein, the term “user interface” generally relates to the interface features through which users interact with the hardware and software of computers and other electronic devices.

It will be readily understood that the components of the present invention, as generally described and illustrated in the figures herein, may be arranged and designed in a wide variety of different configurations. Thus, the following detailed description of the embodiments, as represented in the attached figures, is not intended to limit the scope of the invention as claimed but is merely representative of selected embodiments of the invention.

One aspect of the invention pertains to methods for displaying and manipulating information within a computer interface. It is contemplated that such a user interface may be, for example, a web browser or software application configured to display data. Further, the method includes assigning a shape, such as a box, to said web pages, non-website tabs, or websites that are assigned tabs. In some embodiments, certain data in a software application can be assigned a shape, such as a box. It is contemplated that the method according to the present disclosure may be used in an application that records info as tabs, for example, information separated by lines or sections, or any other software application that displays data. In some embodiments, the method includes the steps of grouping and managing data assigned to a shape.

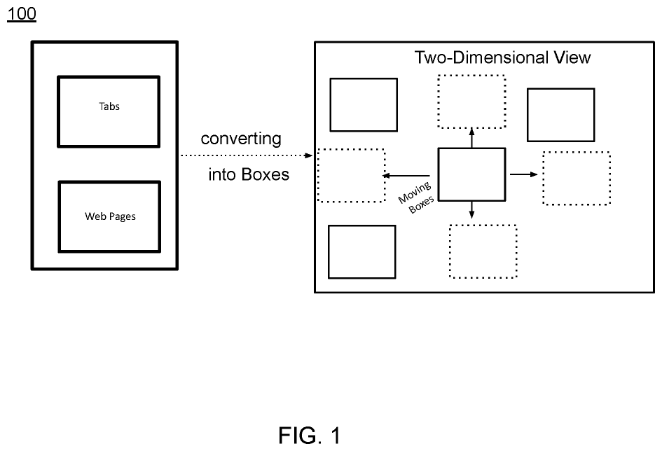

FIG. 1 illustrates a perspective view of boxes showing the management of internet web browser tabs or websites, in accordance with an embodiment of the present invention. When a user launches a browser to conduct a search, he or she may notice a bookmark tab, an extension tab, recent searches, or history, and so forth. The user may perform a plurality of operations including closing a tab, closing a site, accessing tab or website name or icon, open a website, navigate to a tab button, click, and drag on a box to move a box or square shown on the browser, and so forth. In an embodiment of the present invention, the user may navigate a web browser page from either a first screen, a second screen, or from both the first and second screens.

The method for grouping and managing web pages or browser tabs is described in one or more embodiments of the present invention. The method may utilize a computer-driven network having at least one user connectable to one or more servers for browsing the tabs on the browser.

The computer-driven network with a communications component is used in the method. The method entails on a device (e.g., a device selected from the group consisting of a mobile phone, a smartphone, an E-reader, a personal digital assistant PDA, a PDA phone, a tablet, a personal computer (PC), a notebook computer, any wearable technology that displays data, and a desktop computer), to group and manage web pages or browser tabs in a browser or software. The method involves the creation of a number of non-browser boxes with the same functionality as browser tabs for non-browser applications, images or text files, or custom text images. The method also includes bookmarking a number of selected boxes from the extension and saving box arrangements using Bookmark and Arrangement-saving functionality that a user has adapted.

In one embodiment of the present invention, the user may open a number of web pages in a browser and sequentially display a number of tabs corresponding to the web pages in the browser's tab bar. The method also includes selecting boxes with a point and drag and performing a variety of functions with a multi-select point and drag. The various functions include moving, coloring, labeling boxes, and so forth. Customizing the names of boxes is also part of the method.

In some embodiments of the present invention, a user can type in boxes and custom name boxes as a one-time name or save the name so that it appears in the box whenever the tab is open. When one box is like this, all the other boxes in the group will be selected by performing association or grouping of boxes.

In one embodiment of the present invention, the user can perform a double-click operation on any of the open tabs to display all of the tabs in the tab group. A multi select point and drag is also used to select boxes and perform a variety of functions. Moving, coloring, labeling boxes, and so forth are among the functions available. Customizing the names of the boxes is also part of the method.

In some embodiments of the present invention, a user can type in boxes and custom name boxes once and save the name so that it appears in the box whenever the tab is open. When one box is like this, all the other boxes in the group will be selected by performing box association or grouping.

The user may label parts such as, but not limited to, canvas, background, individual boxes, groups of boxes, areas of the canvas with text or color, or any combination thereof, using the method that includes typing and coloring areas in canvas. The method consists of the user previewing the page in the box as a thumbnail using a preview function. The method also includes automatically grouping and arranging boxes or tabs by words in the tab name or URL, alphabetically, or most recently up opened. In preferred embodiments of the present invention, the tabs or web pages may be converted into boxes in a two-dimensional manner. The boxes may move in the left, right, up, and down directions.

In another embodiment of the present invention, metadata might be used to group and manage web pages or tabs in a two-dimensional hierarchy. A tabbed browser window with a number of open tabs, each with content associated with it, may be displayed on the device in an exemplary scenario. In addition, in response to a user action, displaying a window on the device, the window displaying a set of graphic views, each graphic view associated with one of the pluralities of open tabs and displaying at least a portion of the content associated with that open tab.

The automatic grouping and arrangement may include vertical arrangements, horizontal arrangements, clustered groups, or any combination thereof, according to embodiments of the present invention. The method also includes creating assignable numbers for each box and a command (such as ctrl-[X]) to navigate to that tab/box via an assignable number for boxes.

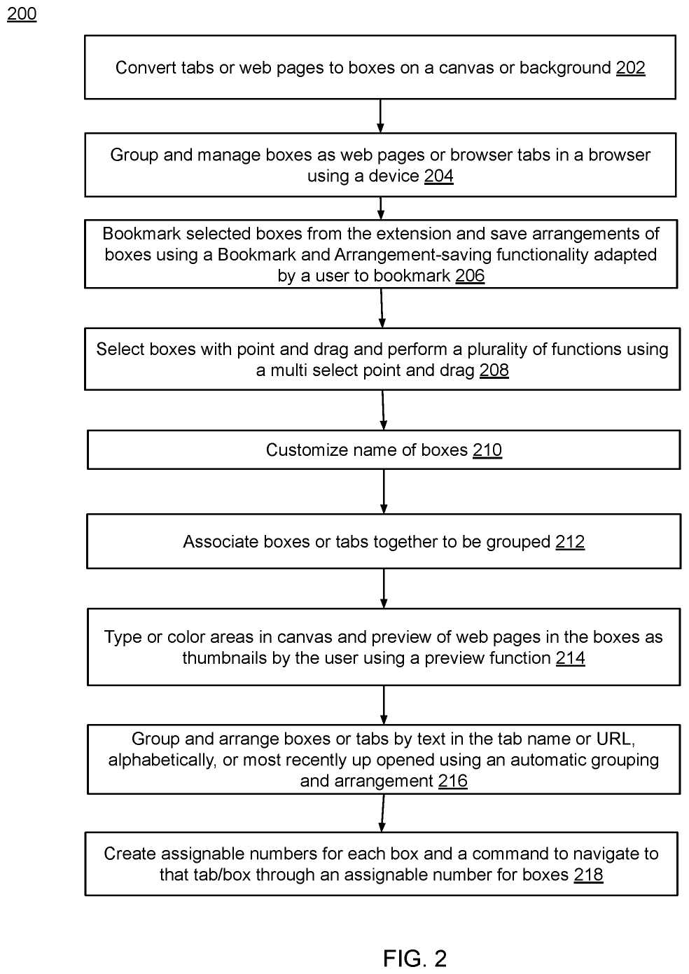

FIG. 2 illustrates a process flowchart 200 for a method for grouping and managing internet web browser tabs, websites, non-browser tabs, or non-browser tabs, in accordance with an embodiment of the present invention. At 202, convert tabs or web pages to boxes on a canvas or background. At 204, grouping and managing boxes as web pages or browser tabs in a browser using a device. At 206, bookmarking a plurality of selected boxes from the extension of the browser or other software and save arrangements of boxes using a Bookmark and Arrangement-saving functionality adapted by a user to bookmark.

Continuing with FIG. 2, at 208, selecting boxes with point and drag and performing a plurality of functions using a multi select point and drag. At 210, customizing the name of boxes. At 212, associating boxes or tabs together to be grouped whenever one box is like this, all the other boxes in the group may be selected also by performing association or grouping of boxes. At 214, type or color areas in canvas. Further, preview web pages in the boxes as thumbnails by the user using a preview function. At 216, grouping and arranging boxes or tabs by text in the tab name or URL, alphabetically, or most recently opened using an automatic grouping and arrangement. At 218, creating assignable numbers for each box and a command to navigate to that tab or box through an assignable number for boxes.

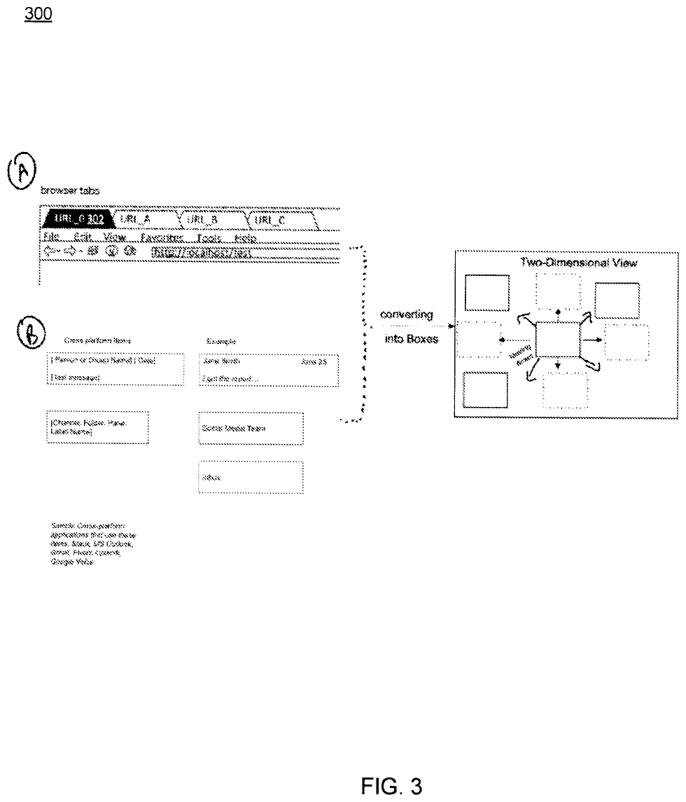

FIG. 3 illustrates a perspective view of boxes showing management of internet web browser tabs or non-browser tabs or websites or tabs from other software applications. While working on a project, a user opens multiple tabs across different browsers, and/or uses other software platforms for communication and/or simultaneously performs a multitude of other activities that the user might want to group together for future reference or cross reference. In an embodiment of the present invention, the user may navigate a web browser tab from multiple screens and simultaneously also engage on other tasks on for example MS Outlook, Gmail, Fiverr, Upwork, Google Voice, Skype and the like. While performing all these operations the user according to an aspect of the present invention can undertake all the activities described in the present disclosure for all the tabs or windows, contacts, or other data/info by converting them into boxes and managing the boxes as desired.

It is envisioned that, in some embodiments, the method according to the present disclosure can be executed on an electronic device during, for example, a lecture, a seminar, a training module, or the like. It is contemplated that such a method can be a useful tool during academic instruction or professional training. It is further envisioned that such a method can be incorporated into software having a primary purpose of docketing, organization, structuring, or the like. In some embodiments, it is envisioned that a method according to the present disclosure may be useful for event planning. In certain embodiments, it is envisioned that such a method can be used in combination with other methods or procedures, for example organizational, instructional, managerial, or the like. In some embodiments, the invention according to the present disclosure includes a kinesthetic or tactile engagement as a result from organizing data in more than one dimension.

It is envisaged that the method according to the present disclosure is useful for storing and rearranging any type of icon displayed on an interface. For example, chat windows, running applications, chat bubbles or the like. Further, it is envisioned that a product of an output file may be manipulated in at least one dimension in accordance with the method of the present disclosure.

The features, structures, or characteristics of the invention described throughout this specification may be combined in any suitable manner in one or more embodiments. For example, the usage of the phrases “example embodiments”, “some embodiments”, or other similar language, throughout this specification refers to the fact that a particular feature, structure, or characteristic described in connection with the embodiment may be included in at least one embodiment of the present invention. Thus, appearances of the phrases “example embodiments”, “in some embodiments”, “in other embodiments”, or other similar language, throughout this specification do not necessarily all refer to the same group of embodiments, and the described features, structures, or characteristics may be combined in any suitable manner in one or more embodiments.

### LIST OF EMBODIMENTS

The following examples are provided solely to illustrate the present invention and are not intended to limit the scope of the invention, described herein.

Embodiment 1. A method for grouping and managing internet web browser tabs, websites, or non-browser tabs, the method comprising: grouping and managing a plurality of web pages or browser tabs in a browser using a device; assigning a box to each web page of the plurality of web pages; and moving, organizing and managing the boxes in two dimensions; bookmarking a plurality of selected boxes from an extension of the browser or other software and saving arrangements of boxes using a Bookmark and Arrangement-saving functionality adapted by a user to bookmark; selecting boxes with a point and drag process and perform a plurality of functions using a multi select point and drag process; customizing a name of two or more boxes; associating boxes or associating tabs together to be grouped by performing association or grouping of boxes; typing and coloring areas in a canvas; previewing a page in a box as a thumbnail using a preview function; and grouping and arranging boxes or tabs by words.

Embodiment 2. The method as Embodied in Embodiment 1, further comprising creating assignable numbers for each box and a command to navigate to that tab or box through an assignable number for boxes.

Embodiment 3. The method as Embodied in Embodiment 1, further comprising management of tabs and windows across platforms.

Embodiment 4. The method of Embodiment 1, wherein grouping and arranging boxes or tabs by words comprises grouping or arranging the boxes or the tabs using a word disposed in a tab name or URL.

Embodiment 5. The method of Embodiment 4, wherein grouping and arranging boxes or tabs by words comprises grouping or arranging the boxes or the tabs alphabetically.

Embodiment 5. The method of Embodiment 4, wherein grouping and arranging boxes or tabs by words comprises grouping or arranging the boxes or the tabs that were most recently opened.

Embodiment 7. The method of Embodiment 1, wherein the device is selected from a group consisting of a mobile phone, a smart phone, an E-reader, a personal digital assistant (PDA), a PDA phone, a tablet personal computer (PC), a notebook computer, and a desktop computer.

Embodiment 8. A non-transitory computer-readable medium which, when executed by a processor, causes a device to perform a method comprising: grouping and managing a plurality of web pages or browser tabs in a browser using a device; assigning a box to each web page of the plurality of web pages; and moving, organizing and managing the boxes in two dimensions; bookmarking a plurality of selected boxes from an extension of the browser or other software and saving arrangements of boxes using a Bookmark and Arrangement-saving functionality adapted by a user to bookmark; selecting boxes with a point and drag process and perform a plurality of functions using a multi select point and drag process; customizing a name of two or more boxes; associating boxes or associating tabs together to be grouped by performing association or grouping of boxes; typing and coloring areas in a canvas; previewing a page in a box as a thumbnail using a preview function; and grouping and arranging boxes or tabs by words.

Embodiments of the present disclosure are described herein, including the best mode known to the inventors for carrying out the invention. Variations of these embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the Embodiments appended hereto as permitted by applicable law. Moreover, any combination of the above-described elements in all possible variations thereof is encompassed by the invention unless otherwise indicated herein or otherwise clearly contradicted by context.

While this invention may be embodied in many different forms, there are described in detail herein specific preferred embodiments of the invention. The present disclosure is an exemplification of the principles of the invention and is not intended to limit the invention to the particular embodiments illustrated. All patents, patent applications, scientific papers, and any other referenced materials mentioned herein are incorporated by reference in their entirety. Furthermore, the invention encompasses any possible combination of some, or all of the various embodiments mentioned herein, described herein and/or incorporated herein. In addition, the invention encompasses any possible combination that also specifically excludes any one or some of the various embodiments mentioned herein, described herein and/or incorporated herein.

Any information in any material (e.g., a United States patent, United States patent application, book, article, etc.) that has been incorporated herein, is only incorporated by reference to the extent that no conflict exists between such information and the other statements and drawings set forth herein. In the event of such conflict, including a conflict that would render invalid any Embodiment herein, then any such conflicting information in such incorporated by reference material is specifically not incorporated by reference herein.

The above disclosure is intended to be illustrative and not exhaustive. This description will suggest many variations and alternatives to one of ordinary skill in this art. All these alternatives and variations are intended to be included within the scope of the Embodiments where the term “comprising” means “including, but not limited to.” Those familiar with the art may recognize other equivalents to the specific embodiments described herein which equivalents are also intended to be encompassed by the Embodiments.

All ranges and parameters disclosed herein are understood to encompass any and all subranges subsumed therein, and every number between the endpoints. For example, a stated range of “1 to 10” should be considered to include any and all subranges between (and inclusive of) the minimum value of 1 and the maximum value of 10; that is, all subranges beginning with a minimum value of 1 or more, (e.g. 1 to 6.1), and ending with a maximum value of 10 or less, (e.g. 2.3 to 9.4, 3 to 8, 4 to 7), and finally to each number 1, 2, 3, 4, 5, 6, 7, 8, 9, and 10 contained within the range. All percentages and proportions herein are by weight unless otherwise specified

It is to be understood that the embodiments and claims are not limited in its application to the details of construction and arrangement of the components set forth in the description and illustrated in the drawings. Rather, the description and the drawings provide examples of the embodiments envisioned, but the claims are limited to the specific embodiments. The embodiments and claims disclosed herein are further capable of other embodiments and of being practiced and carried out in various ways. Also, it is to be understood that the phraseology and terminology employed herein are for the purposes of description and should not be regarded as limiting the claims.

Accordingly, those skilled in the art will appreciate that the conception upon which the application and claims are based may be readily utilized as a basis for the design of other structures, methods, and systems for carrying out the several purposes of the embodiments and claims presented in this application. It is important, therefore, that the claims be regarded as including such equivalent constructions.

Furthermore, the purpose of the foregoing Abstract is to enable the U.S. Patent and Trademark Office and the public generally, and especially including the practitioners in the art who are not familiar with patent and legal terms or phraseology, to determine quickly from a cursory inspection the nature and essence of the technical disclosure of the application. The Abstract is neither intended to define the claims of the application, nor is it intended to be limiting to the scope of the claims in any way. It is intended that the application is defined by the claims appended hereto.

This completes the description of the preferred and alternate embodiments of the invention. Those skilled in the art may recognize other equivalents to the specific embodiment described herein which equivalents are intended to be encompassed by the Embodiments attached hereto.

What is claimed is:

1. A method for grouping and managing internet web browser tabs, websites, or non-browser tabs, the method comprising:
grouping and managing a plurality of web pages, non-browser tabs, or browser tabs in a browser using a device;
assigning a box to each web page or non-browser tabs of the plurality of web pages; and moving, organizing and managing the boxes in two dimensions;
bookmarking a plurality of selected boxes from an extension of the browser or software and saving arrangements of boxes using a Bookmark and Arrangement-saving functionality adapted by a user to bookmark;
selecting boxes with a point and drag process and performing a plurality of functions using a multi select point and drag process;
customizing a name of two or more boxes;
associating boxes or associating tabs together to be grouped by performing association or grouping of boxes;
typing and coloring areas in a canvas;
previewing a page in a box as a thumbnail using a preview function; and
grouping and arranging boxes or tabs by words.

2. The method as claimed in claim 1, further comprising creating assignable numbers for each box and a command to navigate to that tab or box through an assignable number for boxes.

3. The method as claimed in claim 1, further comprising management of tabs and windows across platforms.

4. The method of claim 1, wherein grouping and arranging boxes or tabs by words comprises grouping or arranging the boxes or the tabs using a word disposed in a tab name or URL.

5. The method of claim 4, wherein grouping and arranging boxes or tabs by words comprises grouping or arranging the boxes or the tabs alphabetically.

6. The method of claim 4, wherein grouping and arranging boxes or tabs by words comprises grouping or arranging the boxes or the tabs that were most recently opened.

7. The method of claim 1, wherein the device is selected from a group consisting of a mobile phone, a smart phone, an E-reader, a personal digital assistant (PDA), a PDA phone, a tablet personal computer (PC), a notebook computer, wearable technology, and a desktop computer.

9. The method of claim 1, further comprising management of tabs within at least one app.

10. The method of claim 1, wherein the management takes place over an x-axis and/or a y-axis.

11. The method of claim 1, wherein said tabs are defined by an icon in a browser.

12. The method of claim 1, wherein said tabs are one selecting from the group consisting of: chat windows, data records, lines of text.

13. The method of claim 1, wherein said method is executable across one or more running applications.

14. The method of claim 1, wherein said method is integrated to operate in the background of one or more running applications.

15. The method of claim 1, further comprising the steps of autonomous reorganization as executed by AI, a processor, or the like.

16. The method of claim 1, further including the steps of relocating the icon or tab after the user is finished.

17. The method of claim 1, wherein said tabs are separate data such as records in a database.

18. A non-transitory computer-readable medium which, when executed by a processor, causes a device to perform a method comprising:
grouping and managing a plurality of web pages or browser tabs in a browser using a device;
assigning a box to each web page of the plurality of web pages; and moving, organizing and managing the boxes in two dimensions;
bookmarking a plurality of selected boxes from an extension of the browser or software and saving arrangements of boxes using a Bookmark and Arrangement-saving functionality adapted by a user to bookmark;
selecting boxes with a point and drag process and performing a plurality of functions using a multi select point and drag process;
customizing a name of two or more boxes;
associating boxes or associating tabs together to be grouped by performing association or grouping of boxes;
typing and coloring areas in a canvas;
previewing a page in a box as a thumbnail using a preview function; and
grouping and arranging boxes or tabs by words.
